(19) United States
(12) Patent Application Publication
(10) Pub. No.: US 2026/0230996 A1
(43) Pub. Date: Aug. 6, 2026

(54) CLEARING A PARTIALLY REJECTED SLICE

(71) Applicant: INTERDIGITAL PATENT HOLDINGS, INC., Wilmington, DE (US)

(72) Inventors: Michael Starsinic, Newtown, PA (US); Samir Ferdi, Kirkland (CA); Anuj Sethi, Ottawa (CA); Ulises Olvera-Hernandez, Saint-Lazare (CA); Saad Ahmad, Montreal (CA)

(73) Assignee: INTERDIGITAL PATENT HOLDINGS, INC., Wilmington, DE (US)

(21) Appl. No.: 19/148,113

(22) PCT Filed: Feb. 9, 2024
(86) PCT No.: PCT/US2024/015142

§ 371 Date: Jul. 15, 2025

Related U.S. Application Data
(60) Provisional application No. 63/484,071, filed on Feb. 9, 2023.

(51) Int. Cl. H04W 48/02; H04W 60/04

(52) U.S. Cl. CPC H04W 48/02; H04W 60/04

(57) ABSTRACT

An embodiment of a wireless-transmit-receive unit (WTRU) is configured to send, to a network, a first request to access a first group of one or more network slices while the WTRU is within a tracking area (TA), to receive, from the network in response to the first request, an indication that at least one of the network slices is available in the TA and a denial of access to the at least one of the available network slices, to determine that a restriction-clearing event has occurred, and to send, to the network in response to determining that a restriction-clearing event has occurred, a second request to access a second group of one or more network slices including the at least one of the available network slices to which the network denied access.

### CROSS-REFERENCE TO RELATED APPLICATION

This application claims the benefit of U.S. Provisional Application No. 63/484,071, filed Feb. 9, 2023, the contents of which are incorporated herein by reference.

### SUMMARY

A Registration Area (RA) is a set of tracking areas (i.e., a Tracking Area Identity (TAI) List). The set of tracking areas includes tracking areas of any Next-Generation-Radio-Access Network (NG-RAN) nodes in a Registration Area for a Wireless Transmit-Receive Unit (WTRU), which also may be called User Equipment (UE).

When building an RA, an Access and Mobility Function (AMF) of a wireless network may take into account various information (e.g., the WTRU's Mobility Pattern and Allowed/Non-Allowed Area).

A Mobility Pattern is a concept that may be used by the AMF to characterize and optimize the WTRU mobility.

The AMF determines and updates the Mobility Pattern of the WTRU based on subscription of the WTRU, statistics of the WTRU mobility, network local policy, and the WTRU assisted information, or any combination of the foregoing. The statistics of the WTRU mobility can be historical or can be an expected WTRU moving trajectory. If a Network Data Analysis Function (NWDAF) is deployed, the statistics of the WTRU mobility can also be analytics (i.e., statistics or predictions) provided by the NWDAF.

And the AMF can use the Mobility Pattern to improve, or even optimize, mobility support provided to the WTRU, for example, Registration Area (RA) allocation.

A requested Network Slice Selection Assistance Information (NSSAI) is an NSSAI provided by the WTRU to a Serving Public Land Mobile Network (PLMN) during registration. A conventional network slice (or just “slice”), for example in 5G, is a logical network that provides specific network capabilities and network characteristics and may run atop a physical infrastructure that is shared with other network slices; therefore, network slicing can be an improvement over a physical network. Each slice, (e.g., each “sliced” portion of the network) can be allocated based on the specific needs of a WTRU running an application or service, use case, or customer. For example, one WTRU running a particular application or service may require high-reliability and security, while another WTRU running another particular application or service may require lower latency and higher data speeds. To support such diverse WTRUs, applications, and/or services, a network-slicing algorithm can reassign resources from the physical infrastructure from one slice instance to another slice instance.

An Allowed NSSAI is a list Indicating the Single NSSAIs (S-NSSAIs), which are values that the WTRU could use in the Serving PLMN in the current Registration Area (RA).

A rejected S-NSSAI may also be called a “rejected slice”. When a network rejects a slice request from a WTRU, it means that the network “refuses” to provide the WTRU with access to, or to generate or to instantiate, a requested slice for one or more reasons (e.g., the network's physical infrastructure cannot support the requested slice or the network is a maximum slice capacity).

A WTRU may receive a Rejected NSSAI from the AMF in a Non-Access Stratum (NAS) message. A Rejected NSSAI is a list of rejected S-NSSAI's. In other words, the Rejected NSSAI is a list of rejected slices. The list of rejected slices may be sent to the WTRU in one or more NAS messages such as Registration Accept, De-Registration Request, WTRU Configuration Update Command, or Registration Reject messages.

Each Rejected S-NSSAI in the Rejected NSSAI is associated with a cause value that indicates why the AMF rejected the slice. The cause value is also used by the WTRU to determine the next time the WTRU is permitted to register to the rejected slice.

The network may send to the WTRU a Rejected NSSAI for the current PLMN or Stand-Alone Non-Public Network (SNPN), where the Rejected NSSAI is a set of S-NSSAI(s) that were included in the requested NSSAI by the WTRU, and the set is rejected by the AMF with the rejection cause “S-NSSAI not available in the current PLMN or SNPN”. If the network accepts the WTRU's registration request and the WTRU receives a Rejected NSSAI for the current PLMN or SNPN, the WTRU does not attempt to use this(these) S-NSSAI(s) in the current PLMN or SNPN until 1) switching off the WTRU, 2) the Universal Integrated Circuit Card (UICC) containing the USIM is removed, 3) the entry of the “list of subscriber data” with the SNPN identity of the current SNPN is updated, or 4) the network sends information to the WTRU indicating the S-NSSAI(s) are no longer considered rejected.

The network may send to the WTRU a Rejected NSSAI for the current registration area, where the Rejected NSSAI is a set of S-NSSAI(s) that were included in the requested NSSAI by the WTRU, and the set is rejected by the AMF with the rejection cause “S-NSSAI not available in the current registration area”. If the network accepts the WTRU's registration request and the WTRU receives a Rejected NSSAI for the current registration area, the WTRU does not attempt to use this(these) S-NSSAI(s) in the current registration area until 1) switching off the WTRU, 2) the WTRU moves, or is moving, out of the current registration area, 3) the UICC containing the UICC with Subscriber Identity Module (USIM) is removed, 4) the entry of the “list of subscriber data” with the SNPN identity of the current SNPN is updated, 5) the rejected S-NSSAI(s) are removed, or 6) the network sends information to the WTRU indicating the S-NSSAI(s) are no longer considered rejected.

The network may send to the WTRU a Rejected NSSAI for the failed or revoked Network Slice-Specific Authentication and Authorization (NSSAA), where the Rejected NSSAI is a set of S-NSSAI(s) sent by the AMF with the rejection cause “S-NSSAI not available due to the failed or revoked network slice-specific authentication and authorization.” If the network accepts the WTRU's registration request and the WTRU receives a Rejected NSSAI for the failed or revoked NSSAA, then the WTRU does not attempt to use this(these) S-NSSAI(s) in the current PLMN or SNPN over any access until 1) switching off the WTRU, 2) the UICC containing the USIM is removed, 3) the entry of the “list of subscriber data” with the SNPN identity of the current SNPN is updated, or 4) the network sends information to the WTRU indicating the S-NSSAI(s) are no longer considered rejected.

The network may send to the WTRU a Rejected NSSAI for the maximum number of WTRUs reached, where the Rejected NSSAI is a set of S-NSSAI(s) included in the requested NSSAI by the WTRU and is sent by the AMF with the rejection cause “S-NSSAI not available due to maximum number of WTRUs reached.” The network may also provide a back-off time value, called T3526, for each rejected slice. If the network accepts the WTRU's registration request and the WTRU receives a Rejected NSSAI for the maximum number of WTRUs reached, the WTRU does not attempt to use this(these) S-NSSAI(s) in the current PLMN or SNPN over the current access until 1) switching off the WTRU, 2) the UICC containing the USIM is removed, 3) the entry of the “list of subscriber data” with the SNPN identity of the current SNPN is updated, 4) until the back-off timer expires, or 5) the network sends information to the WTRU indicating the S-NSSAI(s) are no longer considered deleted.

In the above examples, when the WTRU receives a rejected slice, the WTRU is prevented from attempting to use (i.e., register to) the slice again until some event occurs. For example, the event might be that the WTRU leaves the PLMN, leaves the RA, or when a back-off timer expires. This can be advantageous because it prevents the WTRU from repeatedly trying to register to a rejected slice. Thus, the WTRU is prevented from generating unnecessary signaling (i.e., attempts to register to a slice that are repeatedly rejected by the network).

The term Partially Rejected S-NSSAI was introduced in relation to an AMF being able to provide information to the WTRU enabling the WTRU to be able to register an S-NSSAI that is a rejected S-NSSAI for the RA when the WTRU moves to a TA supporting the S-NSSAI. The AMF can provide an additional Information Element (IE) to the WTRU e.g., Partially Rejected S-NSSAI in the registration procedure and the WTRU configuration update procedure, for example, if the WTRU indicates that it supports this feature. By initiating a registration update procedure, the WTRU is able to request a rejected S-NSSAI in a supported TA based on the supported/not supported TA information associated with this S-NSSAI. The current concept of Allowed NSSAI and uniform support of it in a WTRU's RA is not impacted by this feature based on indication of where in the RA certain rejected S-NSSAIs are supported/not supported. In this approach, the Allowed NSSAI is still uniformly supported in the RA.

A Partially Rejected S-NSSAI may also be called a “partially rejected network slice” or an “S-NSSAI that is rejected partially in the RA” or an “S-NSSAI that is rejected with cause ‘partially in the RA.’”

A 5G System may support the Partially-Rejected-S-NSSAI feature that is described above.

An AMF may provide, to the WTRU in the Registration Accept message or in the WTRU Configuration Update Command message, a list of S-NSSAI(s) that are rejected partially in the RA. The registration accept message may then include:
a registration area (RA) that is a list of TAs, and
a RA-subset-availability-info-list.

The RA-subset-availability-info-list may be a list of TAs that are a subset of the RA and either:
represents the list of TAs where one or more slices are to be considered rejected, or
represents the list of TAs where one or more slices are to be considered available and may be requested.

When the network indicates to the WTRU that a slice is rejected “partially in the RA,” the WTRU is allowed to initiate a Mobility Registration Update procedure to request registration with the S-NSSAI only when the WTRU uses the RA-subset-availability-info-list to determine that the S-NSSAI is available in the WTRU's current TA.

As described above, a principle of network slicing is that the WTRU typically is prevented from continuously attempting to register to a rejected slice. The WTRU is configured to attempt to register to a rejected slice after some event has cleared, or invalidated, the conditions on which the rejection of the slice was based. Some of the examples of such an event are described above and include the WTRU leaving a registration area, the WTRU leaving a PLMN, and a back-off timer expiring.

As described above, in an existing 5G System, when the network indicates to the WTRU that a slice is rejected “partially in the RA,” the WTRU is allowed to initiate a Mobility Registration Update procedure to request registration with the S-NSSAI only when the WTRU uses the RA-subset-availability-info-list to determine that the S-NSSAI is available in the WTRU's current TA.

An existing 5G System design may present a problem in this example scenario where the WTRU:
is located in a first TA (e.g., corresponding to current WTRU location),
receives an indication from the network that a slice is partially rejected, and
the content of the RA-subset-availability-info-list indicates that the partially rejected slice is available in the first TA.

The above example may present a problem because the WTRU may continuously attempt to register to the partially rejected slice while the WTRU is in the first TA. This situation may occur in the following scenarios.
The AMF may choose to reject the slice because the AMF prefers to build an RA for the WTRU that includes TAs where the rejected slice is not available. In other words, in some situations, the AMF may prioritize building a large RA over allowing the rejected slice. The AMF may prefer a larger RA because a larger RA my result in reduced signaling from the WTRU. The AMF may desire to build a large RA because the AMF anticipates, based on the WTRU Mobility Pattern, that the WTRU is likely to travel to locations where the slice is not available. For example, the AMF may know, or anticipate, that the WTRU's trajectory will soon take the WTRU to a location where the rejected S-NSSAI is not available.
The AMF may choose to not allow the slice because, based on local policies, the AMF does not want to allow the rejected slice with a second slice that was allowed.

It might be poor system design if it were assumed that the network will always allow the slice for the WTRU if the slice is available in the WTRU's current TA (i.e., the first TA). The reason that this might be poor system design is that it would restrict the AMF such that the AMF might always need to build an RA that only includes the slices where a slice requested by the WTRU is available. In other words, in the scenario where the AMF would always allow a requested slice instead of partly rejecting it, it could impose constraints on how the AMF can construct the RA (e.g., smaller RA) and/or lead to unwanted signaling overhead as the WTRE moves away from the (e.g., limited) area where the slice is available.

In the example scenario above, if the RA-subset-availability-info-list represents a list of TA(s) where the slice is not rejected, then the content of the RA-subset-availability-info-list may indicate that the partially rejected slice is available in the current TA by inclusion of the current TA in the RA-subset-availability-info-list.

In the example scenario above, if the RA-subset-availability-info-list represents a list of TA(s) where the slice is rejected, then the content of the RA-subset-availability-info-list may indicate that the partially rejected slice is available in the current TA by exclusion of the current TA from the RA-subset-availability-info-list.

In an embodiment, a 5G System is enhanced so that a WTRU can attempt to register to a slice that is available in the WTRU's current TA even if the WTRU receives a rejection in the current TA (i.e., partly rejected slice). The enhancements also allow the network to control when and how the WTRU can request the partly rejected slice.

An embodiment of a method for a WTRU to clear a Partial Slice Rejection includes the following actions.
The WTRU first sends a first registration request message associated with a first tracking area of a registration area, wherein the first registration request includes:
   (1) information indicating a set of slices which are requested by the WTRU; and
   (2) information indicating support for partially rejected slices.
Next, the WTRU receives a first registration accept message which includes:
   (1) information indicating a set of slices which are allowed for the WTRU;
   (2) information indicating that a first slice of the set of slices which were requested is rejected; and
   (3) information indicating that the first slice is available in the first tracking area of the registration area.

Next, on condition that the WTRU received the information indicating that the first slice is available in the first tracking area and of the WTRU determining that a restriction clearing event has occurred, sending, with the WTRU, a second registration request message associated with the first tracking area of the registration area, wherein the second registration request includes:
information indicating at least the first slice of the set of slices is requested by the WTRU.
Next, the WTRU receives, from the network entity, a second registration accept message which includes:
   information indicating that the first slice of the set of slices is allowed for the WTRU.

In an embodiment, determining that a restriction-clearing event has occurred involves constructing a Requested NSSAI that includes the first slice and that does not include at least one other slice that is part of the set of slices that are allowed for the WTRU, and the second registration request message includes the Requested NSSAI.

In an embodiment, determining that a restriction-clearing event has occurred involves constructing a Requested NSSAI that includes the first slice and does not include at least one other slice that is part of the set of slices that were requested by the WTRU, and the second registration request message includes the Requested NSSAI.

In an embodiment, determining that a restriction-clearing event has occurred involves constructing a Requested NSSAI that includes the first slice and determining to include, in the second registration request message, an indication to the network that the WTRU is requesting a partially rejected slice.

In an embodiment, the first registration accept message includes a back-off time that is associated with the first slice and determining that a restriction-clearing event has occurred involves using the back-off time to configure a timer and detecting that the timer has expired.

In an embodiment, determining that a restriction-clearing event has occurred involves detecting that a periodic registration timer has expired or determining to perform a periodic registration.

A method performable by a WTRU includes sending, to a network, a first request for registering with the network, for communicating via a slice of the network, and associated with a first tracking area; receiving, from the network, in response to the first request, a first registration-accept message that includes a rejection of the request to communicate via the slice and an indication that the slice is available in the first tracking area; determining that a restriction-clearing event has occurred; and sending, to the network, in response to the occurrence of the restriction-clearing event, a second request for registering with the network, for communicating via the slice, and associated with the first tracking area.

An embodiment of a WTRU is configured to send, to a network, a first request for registering with the network, for communicating via a slice of the network, and associated with a first tracking area; to receive, from the network, in response to the first request, a first registration-accept message that includes a rejection of the request to communicate via the slice and an indication that the slice is available in the first tracking area; to determine that a restriction-clearing event has occurred; and to send, to the network, in response to the occurrence of the restriction-clearing event, a second request for registering with the network, for communicating via the slice, and associated with the first tracking area.

Another embodiment of a method performable by a (WTRU) includes sending, to a network, a first request to access a first group of one or more slices while the WTRU is within a tracking area (TA); receiving, from the network in response to the first request, an indication that at least one of the slices is available in the TA and a denial of access to the at least one of the available slices; determining that a restriction-clearing event has occurred; and sending, to the network in response to determining that a restriction-clearing event has occurred, a second request to access a second group of one or more slices including the at least one of the available slices to which the network denied access.

Another embodiment of a wireless-transmit-receive unit (WTRU) is configured to send, to a network, a first request to access a first group of one or more slices while the WTRU is within a tracking area (TA); to receive, from the network in response to the first request, an indication that at least one of the slices is available in the TA and a denial of access to the at least one of the available slices; to determine that a restriction-clearing event has occurred; and to send, to the network in response to determining that a restriction-clearing event has occurred, a second request to access a second group of one or more slices including the at least one of the available slices to which the network denied access.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of a method that can be implemented by a WTRU and in which the WTRU attempts to register to a first network slice and the network indicates that the slice is partially rejected, according to an embodiment.

FIG. 3 is a flow chart of a method that can be implemented by a WTRU and in which the WTRU attempts to register to a partially rejected network slice in response to the occurrence of a restriction-clearing event, according to an embodiment.

### DETAILED DESCRIPTION

### Abbreviations and Acronyms

AMF Access and Mobility Function
Graphical User Interface
IE Information Element
NAS Non-Access Stratum
NG Next Generation
NPN Non-Public Network
NSSAI Network Slice Selection Assistance Information
NSSAA Network Slice-Specific Authentication and Authorization
NWDAF Network Data Analytics Function
PLMN Public Land Mobile Network
RA Registration Area
RAN Radio Access Network
S-NSSAI Single NSSAI
SIM Subscriber Identity Module
TA Tracking Area
TAI TA Identity
UE User Equipment such as a Wireless Transmit-Receive Unit
SNPN Standalone NPN
UICC Universal Integrated Circuit Card
USIM UICC with SIM
WTRU Wireless Transmit-Receive Unit

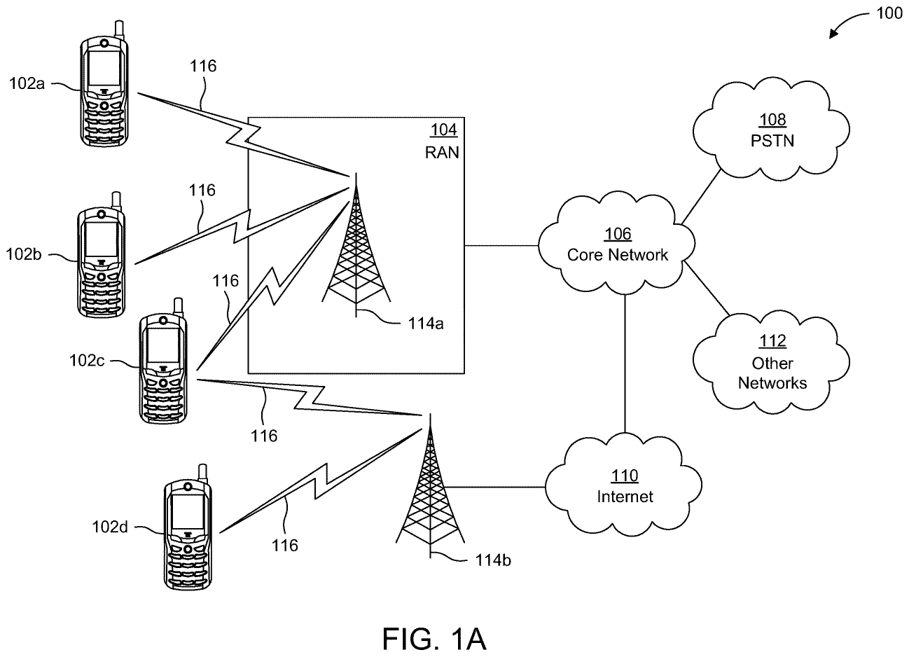

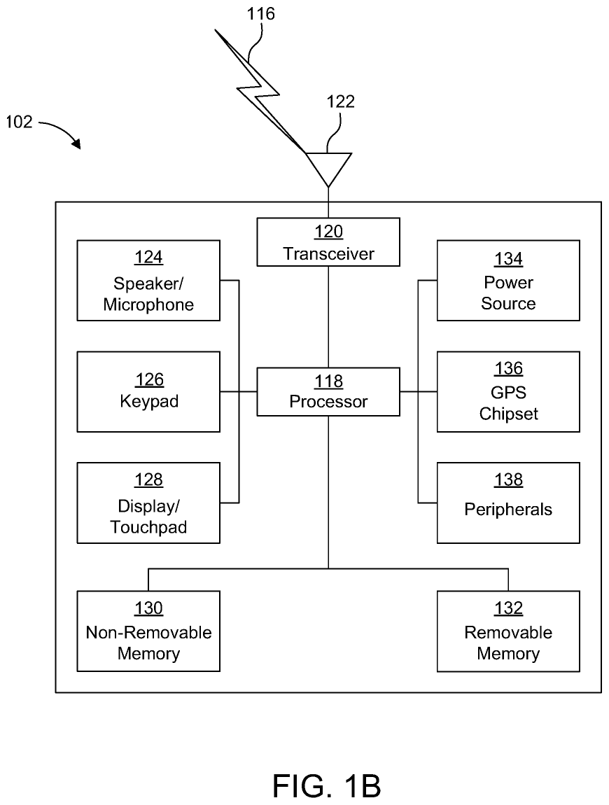

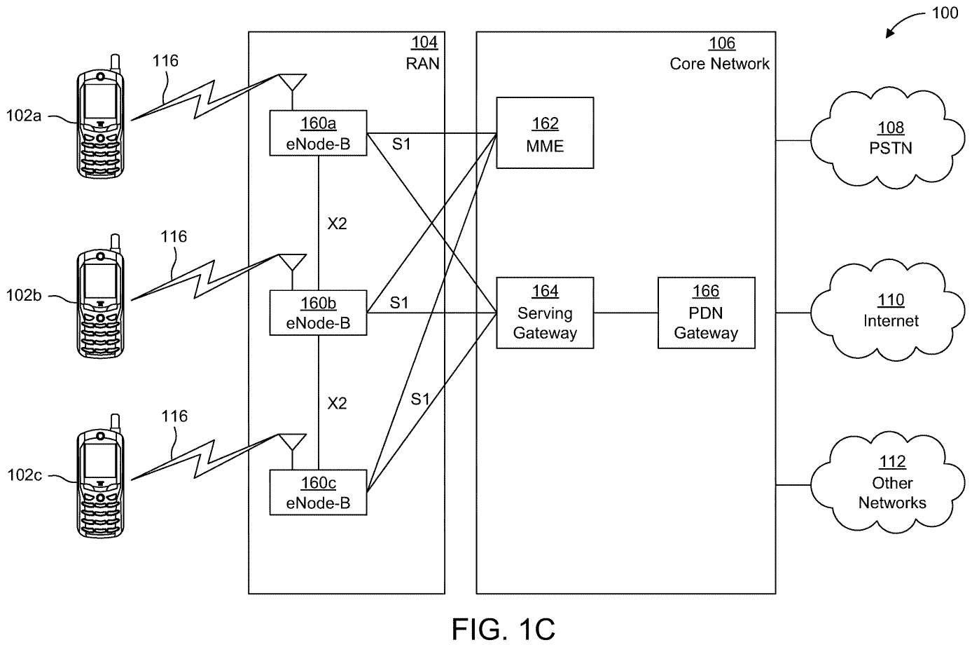

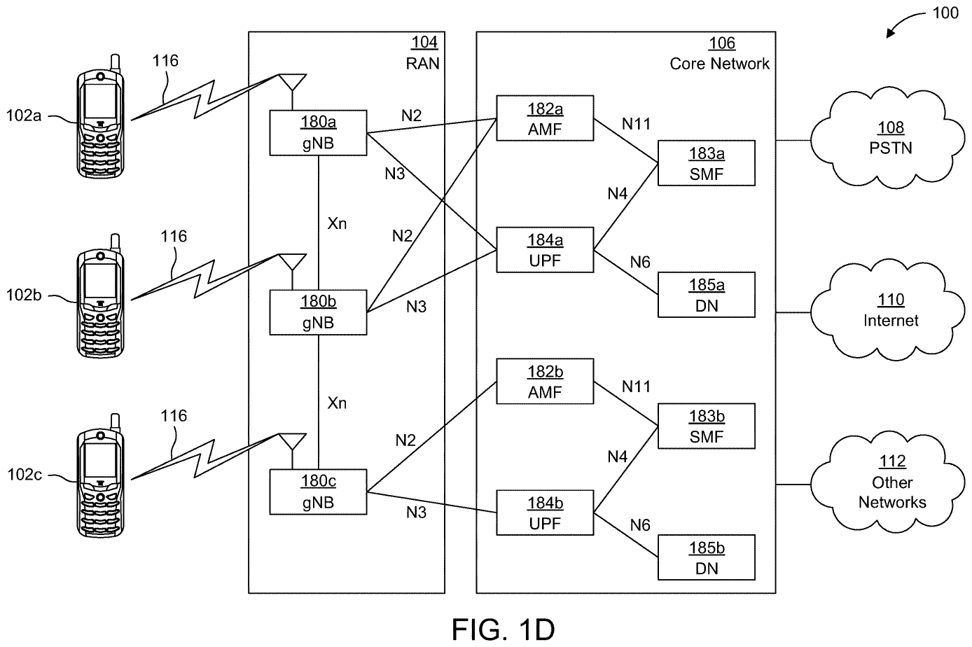

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As described above, a principle of network slicing in conventional networks is that the WTRU is prevented from continuously attempting to register to a rejected slice. The WTRU is configured to attempt to register to a rejected slice only after some event has cleared, or invalidated, the rejection conditions. The example clearing and/or invalidating events described above include the WTRU leaving a registration area, the WTRU leaving a Public Land Mobile Network (PLMN), and/or a backoff timer expiring.

As further described above, the existing 5G System is such that when a network indicates to the WTRU that a slice is rejected “partially in the RA,” the WTRU is allowed to initiate a Mobility Registration Update procedure to request registration with the S-NSSAI when the WTRU uses the RA-subset-availability-info-list to determine that the S-NSSAI is available in the WTRU's current TA.

The existing 5G System design may present a problem in the example scenario where the WTRU:
is located in a first TA (e.g., corresponding to current WTRU location),
receives an indication from the network that a slice is partially rejected, and
the content of RA-subset-availability-info-list indicates that the partially rejected slice is available in the first TA.

The above example may present a problem because the WTRU may continuously attempt to register to the partially rejected slice while the WTRU is in the first TA. For example, this situation may occur in the following scenarios:
The AMF may choose to reject the slice because the AMF is configured to build an RA for the WTRU that includes TAs where the rejected slice is not available. In other words, in some situations, the AMF may prioritize building a large RA over allowing the rejected slice. The AMF may be configured to build a larger RA because a larger RA my result in reduced signaling from the WTRU. The AMF may be configured to build a large RA because the AMF determines, based on the WTRU Mobility Pattern, that the WTRU is likely to travel to locations where the slice is not available. For example, the AMF may determine that the WTRU's trajectory, if unchanged, will soon take the WTRU to a location where the rejected S-NSSAI is not available.
The AMF may determine not to allow the slice because, based on local policies, the AMF does not allow the rejected slice with a second slice that was allowed.

Designing a system under the assumption that a network always will allow a slice for a WTRU if the slice is available in the WTRU's current TA (i.e., the first TA) is potentially a poor choice. The reason that such a design may be poor is that such a design might restrict the AMF such that the AMF would be forced to build an RA that includes only the slices where the slice is available. In other words, in the scenario where the AMF is designed to allow, always, a slice instead of partly rejecting it, this design potentially imposes constraints on how the AMF can construct the RA (e.g., a smaller RA) and/or lead to unwanted signaling overhead as the WTRU moves away from the (e.g., limited) area where the slice is available.

In the example scenario above, if the RA-subset-availability-info-list represents a list of TA(s) where the slice is not rejected, then the content of the RA-subset-availability-info-list may indicate that the partially rejected slice is available in the current TA (i.e., the TA in which the WTRU is currently located) by inclusion of the current TA in the RA-subset-availability-info-list.

Still in the example scenario above, if the RA-subset-availability-info-list represents a list of TA(s) where the slice is rejected, then the content of the RA-subset-availability-info-list may indicate that the partially rejected slice is available in the current TA by exclusion of the current TA from the RA-subset-availability-info-list.

Described herein are 5G System enhancements, according to an embodiment, that allow a WTRU to attempt to register to a slice that is available in the WTRU's current TA (i.e., the first TA) even when the WTRU receives the rejection in the current TA. The described enhancements also prevent the WTRU from continually requesting the same combination of slices from the network.

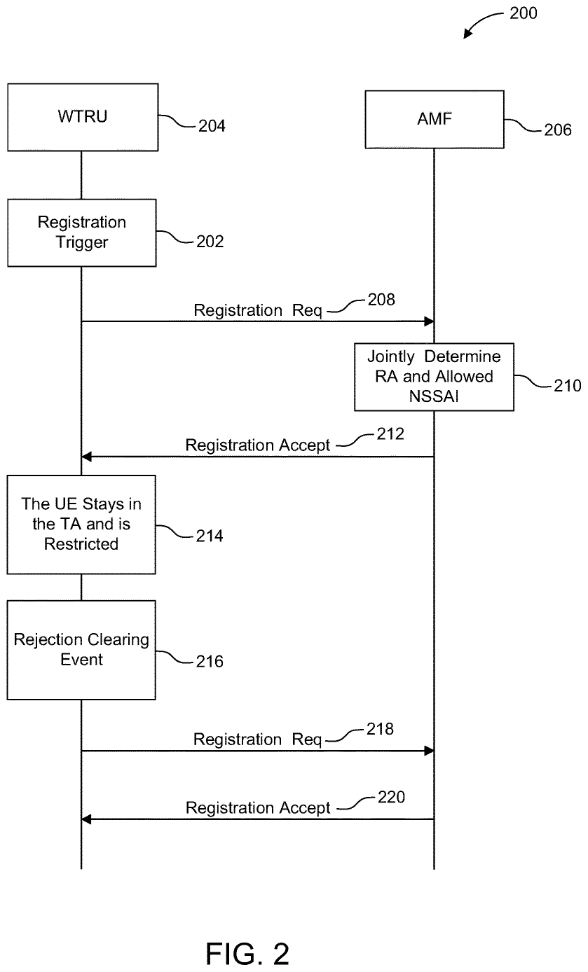

FIG. 2 is a diagram 200 of a procedure where the WTRU attempts to register to a first network slice and the network indicates that the slice is partially rejected, according to an embodiment. Furthermore, in this procedure, the network indicates that although the slice is available in the WTRU's current TA, the WTRU is restricted from attempting to register to the slice again while the WTRU is in the TA, unless a rejection-clearing event occurs. FIG. 2 illustrates that the rejection-clearing event may occur and that the WTRU may then attempt again to register to the first network slice while still in the same TA. In this procedure, the Rejection Clearing Event may be triggered by the WTRU or detected by the WTRU. Examples of the Rejection Clearing Event are listed below.

At 202, a WTRU 204 located in a first tracking area is triggered to send a Registration Request to a network (represented by, and including, an AMF 206). The WTRU 204 may be triggered to send the Registration Request to the network when the WTRU leaves an RA, when a periodic registration timer expires, when a power-on event occurs, when an application requests to access a slice that is identified by an S-NSSAI, or when the WTRU detects a particular type of traffic is being generated by an application that is hosted on the WTRU.

A 208, the WTRU 204 sends a Registration Request to the AMF 206 of the network. The Registration Request includes a Requested NSSAI and the Requested NSSAI includes at least two S-NSSAIs (e.g., slice A and slice B). The S-NSSAIs in the Requested NSSAI are an indication from the WTRU 204 to the network for which slices the WTRU requests registration. The Registration Request may further indicate to the network that the WTRU 204 supports the Partially Rejected Slice feature and is, therefore, capable of receiving and using an RA-subset-availability-info-list information element.

At 210, the AMF 206 receives the Registration Request and determines which one or more slices from the at least two S-NSSAIs in the Requested NSSAI to allow, and the AMF builds, accordingly, an RA for the WTRU 204. Building an RA means constructing a list of TA(s) that define the WTRU's RA. As explained above, how the AMF 206 determines which slices to include in the Allowed NSSAI and how the AMF builds the RA are largely based on AMF implementation (e.g., based on WTRU Mobility Patterns). For example, the AMF 206 chooses to allow one or more of the slices from the Requested NSSAI of the Registration Request 208. Allowing a slice means putting the S-NSSAI of the slice in the Allowed NSSAI. For example, the AMF 206 can reject one or more of the slices from the Requested NSSAI at 210. Rejecting a slice may mean putting the S-NSSAI of the slice in a Rejected NSSAI. For example, the AMF 206 partially rejects one of the slices from the Requested NSSAI of the Registration Request at 210. Partially rejecting a slice may mean putting the S-NSSAI of the slice in a Rejected NSSAI and constructing, for the WTRU, an RA-subset-availability-info-list that indicates the availability status of the slice.

The AMF 206 may select an RA that includes multiple TAs to decrease the likelihood that the WTRU 204 will perform Mobility Registration Updates. As described above, the AMF 206 may select the RA based on the WTRU's Mobility Pattern. It is noted that the WTRU's Mobility Pattern is based on past behavior and may not be indicative of future behavior. In other words, as an example, the WTRU Mobility Pattern may lead the AMF 206 to anticipate that the WTRU 204 will be mobile when, in fact, the WTRU will be stationary.

The AMF 206 (of the network) may also receive slice-priority information form the WTRU 204 or from the WTRU's subscription information from the Unified Data Manager (UDM)/Unified Data Repository (UDR) of the network. The AMF 206 may use this information when determining whether to partially reject or to allow a network slice. For example, if a slice has a higher priority than other slices that the WTRU 204 requests, then the AMF 206 may determine to allow the slice a priori (e.g., in a smaller RA) as the WTRU is presumed to use that slice in priority relatively to other slices. Otherwise, if the slice priority is lower than other requested slices, then the AMF 206 may be more likely to provide a larger RA and partially reject the slice as the WTRU 204 is presumed to prioritize one or more others of the requested slices.

At 212, the AMF 206 sends a Registration Accept Message to the WTRU 204.

The Registration Accept Message includes the Allowed NSSAI(s), Registration Area, and Rejected NSSAI(s) that were determined at 210. The AMF 206 may further indicate to the WTRU 204 that one of the rejected slices (e.g., Slice B) is partially rejected in the RA. The AMF 206 sends a RA-subset-availability-info-list for the slice that is rejected in the RA. The presence of an RA-subset-availability-info-list information element may serve as an indication to the WTRU 204 that the slice is partially rejected in the RA. In this example, the list of TA(s) in the RA and RA-subset-availability-info-list are used by the WTRU 204 to determine that a partially rejected slice is available in the WTRU's current TA. In other words, the information in the list of TA(s) in the RA and RA-subset-availability-info-list indicate to the WTRU that a partially rejected slice (e.g., Slice B) is available in the WTRU's current TA. As an example, the Registration Accept Message may include an indication that a Slice A is allowed and that a Slice B is partially rejected but is available in the WTRU's current TA. Note that the Registration Area, Allowed NSSAI(s), Rejected NSSAI(s), and RA-subset-availability-info-list information elements for the slice(s) that are rejected in the RA may also be sent to the WTRU 204 in the WTRU Configuration Update Command.

When the Registration Accept Message indicates that a partially rejected slice is available in the WTRU's current TA, the Registration Accept Message may also indicate what event(s) should or must occur prior to the WTRU 204 again requesting the partially rejected slice that is available in the TA.

At 214, the WTRU 204 stays in the TA and refrains from requesting to register the partially rejected slice. This means that the WTRU refrains from sending a Registration Request with the partially rejected slice (e.g., Slice B) in the Requested NSSAI of the Registration Request until the WTRU detects an event that clears this restriction. Said another way, the WTRU 204 is restricted from requesting to register the partially rejected slice until the restriction is cleared, e.g., by the occurrence of an event.

At 216, the WTRU 204 detects an event that removes (e.g., clears) the restriction against the WTRU attempting to request to register to the partially rejected slice (e.g., Slice B) or the WTRU triggers an event that removes the restriction against the WTRU attempting to request to register to the partially rejected slice. Examples of the events that can be detected or triggered by the WTRU 204 are described below.

At 218, the WTRU 204, which is still in the same TA that it was in when the message (Registration Accept) at 212 was received, sends a new Registration Request to the network (having the AMF 206). The Requested NSSAI includes the S-NSSAI of the slice (e.g., Slice B) that was partially rejected at 212.

At 220, the WTRU 204 receives a Registration Accept message, which includes an Allowed NSSAI, and the S-NSSAI of the slice (e.g., Slice B) that was partially rejected at 212 is included in the Allowed NSSAI. Consequently, the WTRU 204 now has access to the slice (e.g., Slice B) that was partially rejected at 212, and, therefore, can register to this previously partially rejected slice (e.g., Slice B).

Referring again to 216 of the diagram 200 of FIG. 2, the WTRU 204 may trigger a clearing of the restriction by building a Requested NSSAI that has the following two characteristics:
1. The Requested NSSAI includes the S-NSSAI of the slice (e.g., Slice B) that was partially rejected; and
2. The Requested NSSAI does not include (e.g., omits) at least one S-NSSAI (e.g., Slice A) that was included in the Allowed NSSAI that was received at 212 of FIG. 2. Or the Requested NSSAI does not include at least one S-NSSAI (e.g., the S-NSSAI for the Slice A) that was included in the Requested NSSAI that was sent at 208 of FIG. 2.

The WTRU 204 may then send the requested nssai to the network (having AMF 206) in the registration request at 218.

Still referring to FIG. 2, this embodiment of a method for clearing a restriction to the WTRU 204 continually attempting to request registration to a combination of slices of which at least one is partially rejected slice is based on the principle that the WTRU 204 should not continue to request a combination of slices if the network (having the AMF 206) has already rejected the combination of slices and no other factors have changed.

Referring to FIG. 2, in this scenario, a user of the WTRU 204 may be presented with a GUI message at 216 that indicates an identity (e.g. S-NSSAI) of the partially rejected slice and prompts the user to select a slice to remove from the set of Allowed slices if the user wants the WTRU 204 to attempt to register to the partially rejected S-NSSAI.

When the WTRU 204 sends the new Requested NSSAI at 218, the WTRU may indicate to the network that an S-NSSAI in the Requested NSSAI was previously partly rejected, and the WTRU has not since changed TA. The AMF 206 may choose to use the indication to determine to send the WTRU a stronger rejection of the S-NSSAI. A stronger rejection may mean that the slice is rejected for the whole RA or that the network indicates that the slice is rejected, or not available, in the TA. The AMF 206 alternatively may choose to use this indication to determine a smaller RA so that the partially rejected slice can now be allowed (e.g., by determining a more static mobility behavior of the WTRU 204).

At 216 of the procedure of FIG. 2, the WTRU 204 may trigger a clearing of the restriction by building a Requested NSSAI that includes the S-NSSAI of the slice that was partially rejected and determining to send the network a Registration Request that includes an indication that the WTRU is requesting registration to a partially rejected slice. The AMF 206, for example, may choose to use this indication to determine a smaller RA so that the partially rejected slice can now be allowed.

The indication to the network (e.g., a network including the AMF 206) that the WTRU 204 is requesting a partially rejected slice may be sent by the WTRU to the network by the WTRU including a Rejected NSSAI, Extended rejected NSSAI, Partially Rejected NSSAI, or Partially Rejected S-NSSAI information element in the Registration Request (e.g., at 218). In other words, the WTRU 204 may request a slice that was previously partially rejected in the TA by also indicating to the network that the slice was previously partially rejected but that the WTRU may also send information to the network so that the network “knows” that the WTRU is “aware” that it is trying to register to a slice that was previously partially rejected. The network (i.e., the network including the AMF 206) may use this information to prioritize allowing the slice that was partially rejected and possibly rejecting a different slice or building a smaller RA.

A similar approach is that, if the WTRU 204 has not changed TA since receiving an S-NSSAI rejected partially in the RA, then the WTRU behaves as if it is not allowed to attempt to register to the S-NSSAI rejected partially until leaving the TA. However, the WTRU 204 may indicate its preference that the S-NSSAI rejected partially in the RA be allowed over the slices in the Allowed NSSAI by sending a Registration Update request and including the S-NSSAI rejected partially in the RA in the Registration Update request at 218. The AMF 206, after receiving the request at 218, may then choose to change the RA and the Allowed NSSAI so that the Allowed NSSAI includes the S-NSSAI rejected partially in the RA.

If the AMF 206 determines to partially reject a slice and the WTRU 204 is in a TA where the slice is not rejected, then the AMF may include a back-off time with the Rejected S-NSSAI. The WTRU 204 may use the back-off time to configure a timer and the WTRU may consider the restriction to be cleared when the back-off time, as counted down by the WTRU timer, expires. Thus, the WTRU 204 may request the partially rejected slice at 218 after the back-off time expires at 216. The back-off timer may be discarded, cleared, deleted, or considered expired by the WTRU 204 if the WTRU leaves the current TA and stays in the current RA. Thus, the back-off time may be considered expired even without a change in RA. The AMF 206 checks that the WTRU 204 does not attempt to request a partially rejected slice before the back-off time expires. Otherwise, the AMF 206 may reject the slice for the entire RA or allow the slice by providing a smaller RA in response. If the AMF 206 decides to partially reject a request after the back-off time expires, then the AMF may partially reject the request again and reissue a new back-off time (e.g., an exponential back-off time).

The WTRU 204 may be configured to behave such that if a partially rejected slice is available in a TA, all restrictions against attempting to register to the slice are removed when a periodic-registration timer expires. The benefit of this approach is that if a periodic registration already is taking place, allowing the WTRU 204 to attempt again to register to the slice will generate only a very small amount of additional signaling and likely no extra messaging because the periodic registration occurs regardless of whether the WTRU attempts to register to a partially rejected slice.

The WTRU 204 may perform mobility registration for various reasons while in the same TA (e.g., to change DRX settings, to register for SMS over NAS, to request new LADN information). If a partially rejected slice becomes available at the time of mobility registration, the AMF 206 may send an explicit indication in the Registration Accept message (at 220) to inform the WTRU 204 to clear the restriction on the partially rejected S-NSSAI. Also, if the WTRU 204 determines to perform a mobility registration while still in the same TA for any reason other than to explicitly change the Allowed NSSAI, then the WTRU 204 may consider that all restrictions against attempting to register to the partially rejected slice are removed.

The AMF 206 may send the WTRU 204 a WTRU Configuration Update Command that includes an indication that any restrictions against the WTRU attempting to register to a partially rejected slice are now removed. This message may be delivered to the WTRU 204 by excluding the partially rejected slice from the WTRU Configuration Update Command message.

As described above, the AMF 206 of a network may send a partially rejected S-NSSAI to the WTRU 204 with a back-off time for the S-NSSAI. The WTRU 204 may be prevented from attempting to register to the S-NSSAI until the back-off time expires or until the WTRU leaves the TA. However, the WTRU 204 may need, or would like, to access the S-NSSAI before leaving the TA and while back-off timer is still running, i.e., still counting down the back-off time. In this scenario, the WTRU 204 may “override” the back-off timer by sending, to the network, a Registration Request that includes a Requested NSSAI that has the following two characteristics.
1. The Requested NSSAI includes the S-NSSAI of the slice that was partially rejected.
2. The Requested NSSAI does not include (i.e., omits) at least one S-NSSAI that was included in the Allowed NSSAI that was received at 212 of FIG. 2. Or the Requested NSSAI does not include (i.e., omits) at least one S-NSSAI that was included in the Requested NSSAI that was sent at 208.

The principle of this approach is that the WTRU 204 is allowed to determine that it can request the partially rejected slice before the back-off time expires if the WTRU requests a combination of slices that is different than the combination that triggered the partial rejection of the slice by the AMF 206.

When the WTRU 204 sends a Requested NSSAI with the partially rejected slice and the back-off timer is still running (i.e., the back-off time has not expired), the WTRU may either:
1. keep the back-off timer running until the partially rejected slice is allowed or rejected non-partially, or
2. reset the back-off timer if the network partially rejects the slice again and provides a new back-off time.

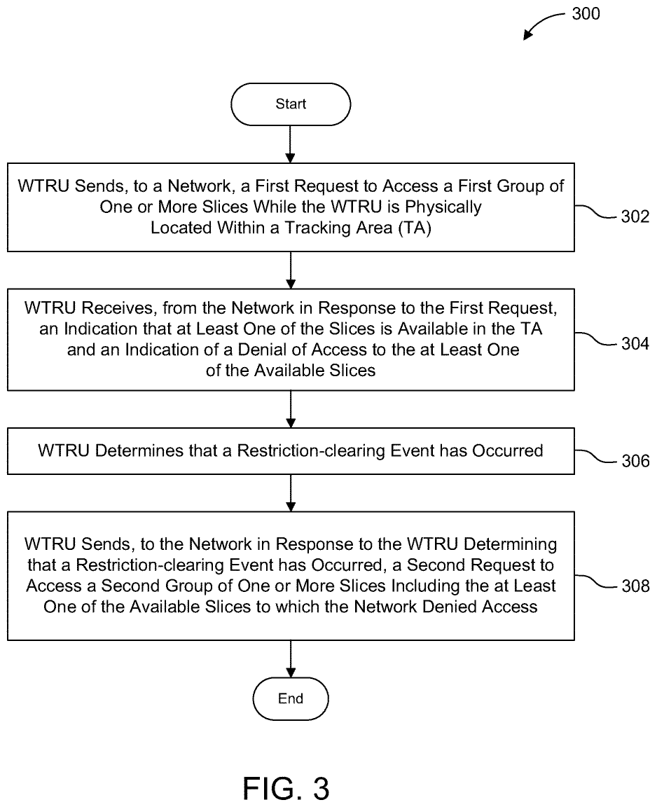

FIG. 3 is a flow chart 300 of a method that can be implemented, or otherwise performed, by a wireless-transmit-receive unit (WTRU) such as the WTRU 204 of FIG. 2, according to an embodiment.

At 302, the WTRU sends, to a network (e.g., a network including an AMF such as the AMF 206 of FIG. 2), a first request to access a first group of one or more slices while the WTRU is within a tracking area (TA).

At 304, the WTRU receives, from the network in response to the first request, an indication that at least one of the slices is available in the TA and an indication of a denial of access to the at least one of the available slices. That is, the WTRU receives an indication that the network has partially rejected the at least one of the available slices.

At 306, the WTRU determines that a restriction-clearing event has occurred. Examples of a restriction-clearing event are given above, and include the WTRU sending, to the network, a request for a different group of slices than in 302 where the different group still includes the partially rejected at least one of the available slices (in this example, the WTRU actually generates the occurrence of the restriction-clearing event), expiration of a back-off time, or expiration of a periodic-registration time

And, at 308, the WTRU sends, to the network in response to determining that a restriction-clearing event has occurred, a second request to access a second group of one or more slices including the at least one of the available slices to which the network denied access.

A non-exhaustive list of examples of one or more of the procedures and methods disclosed herein includes the following.

For the following examples, assume that a WTRU that is physically located in TA1 sends a request (e.g., a Requested NSSAI) to a network for registration to Slices A, B, C, and D, and the WTRU would “like” most to access Slice C.

The network grants the WTRU access to Slices A and B, but partially rejects slices C and D via an Allowed NSSAI.
1) The WTRU can generate a restriction-clearing event by sending another request (e.g., a Requested NSSAI) for access to Slices A, C, and D; the WTRU may generate the request to include an indication that the WTRU is requesting a previously partially rejected Slice C.
2) If the WTRU moves out of TA1 and into TA2 (where the network previously indicated to the WTRU that at least Slice C is available in TA2), then the WTRU can generate a restriction-clearing event by sending another request (e.g., a Requested NSSAI) for access to Slices A, B, C, and D; the WTRU may generate the request to include an indication that the WTRU is requesting a previously partially rejected Slices C and D. Or the WTRU may generate the request to include an indication that the WTRU is requesting a previously partially reject Slice C if the WTRU doesn't really “care” about accessing Slice D.
3) If the WTRU receives, from the network, a back-off time, then the WTRU can instantiate a back-off timer that counts down the back-off time, and, in response to the elapse of the back-off time, the WTRU can send another request (e.g., a Requested NSSAI) to the network for registration to Slices A, B, C, and D.
4) The WTRU can await the elapse of a time counted down by an existing timer, such as a periodic-registration time, and then, in response to the elapse of the time being counted down, the WTRU can send another request (e.g., a Requested NSSAI) for Slices A, B, C, and D (or any subset thereof) along with information (e.g., periodic-registration information) that the WTRU is sending to the network anyway, e.g., for a reason other than requesting access to a partially rejected slice.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-36. (canceled)

37. A method performed by a wireless transmit/receive unit (WTRU), the method comprising:
sending, to a network, a first request to access a first group of one or more network slices while the WTRU is within a tracking area (TA);
receiving, from the network in response to the first request, an indication that at least one slice is available in the TA and a denial of access to at least one of the available slices;
determining that a restriction-clearing event has occurred; and
sending, to the network in response to determining that the restriction-clearing event has occurred, a second request to access a second group of one or more slices including the at least one slice to which the network denied access.

38. The method of claim 37, wherein determining that the restriction-clearing event has occurred includes determining that a back-off timer has expired.

39. The method of claim 37, wherein determining that the restriction-clearing event has occurred includes determining that a periodic registration timer has expired.

40. The method of claim 37, further comprising causing the restriction-clearing event to occur.

41. The method of claim 37, further comprising:
receiving, from the network, an indication that a second slice is available in the TA and access is allowed to the second slice; generating the second request such that the second group omits the second slice to which access was allowed; and d
determining that the restriction-clearing event has occurred in response to generating the second request.

42. The method of claim 37, wherein the restriction-clearing event comprises a mobility-related event including a change in the tracking area or a handover to a different base station.

43. The method of claim 37, wherein the second request includes a different slice selection assistance information (SSAI) than the first request.

44. The method of claim 37, wherein the WTRU detects an indication from the network that restriction conditions have been lifted, and wherein the restriction-clearing event is determined based on detecting the indication.

45. A wireless transmit/receive unit (WTRU) configured to:
send, to a network, a first request to access a first group of one or more network slices while the WTRU is within a tracking area (TA);
receive, from the network in response to the first request, an indication that at least one slice is available in the TA and a denial of access to at least one of the available slices; determine that a restriction-clearing event has occurred;
and send, to the network in response to determining that the restriction-clearing event has occurred, a second request to access a second group of one or more slices including the at least one slice to which the network denied access.

46. The WTRU of claim 45, wherein the WTRU is configured to determine that the restriction-clearing event has occurred upon expiration of a back-off timer.

47. The WTRU of claim 45, wherein the WTRU is configured to determine that the restriction-clearing event has occurred upon expiration of a periodic registration timer.

48. The WTRU of claim 45, wherein the WTRU is configured to cause the restriction-clearing event to occur.

49. The WTRU of claim 45, wherein the WTRU is further configured to: receive, from the network, an indication that a second slice is available in the TA and access is allowed to the second slice; generate the second request such that the second group omits the second slice to which access was allowed; and determine that the restriction-clearing event has occurred in response to generating the second request.

50. The WTRU of claim 45, wherein the restriction-clearing event comprises a change in the tracking area or a mobility-triggered handover.

51. The WTRU of claim 45, wherein the WTRU is configured to modify the slice
